(19) United States
(12) Patent Application Publication
(10) Pub. No.: US 2021/0003830 A1
(43) Pub. Date: Jan. 7, 2021

(54) COMPACT DUAL-BAND SENSOR

(71) Applicant: RAYTHEON COMPANY, Waltham, MA (US)

(72) Inventor: Elka E. Koehler, Tucson, AZ (US)

(21) Appl. No.: 16/502,986

(22) Filed: Jul. 3, 2019

(51) Int. Cl. G02B 13/14; G02B 23/12; G02B 17/08; G02B 17/06; G01J 3/02; G01J 3/28

(52) U.S. Cl. CPC G02B 13/146; G02B 23/12; G02B 17/0808; G01J 3/2823; G01J 3/021; G01J 3/0208; G02B 17/0663

(57) ABSTRACT

Dual-band optical imaging systems and methods. One example of a dual-band optical system includes an all-reflective shared optical sub-system configured to receive combined optical radiation including first optical radiation having wavelengths in a first waveband and second optical radiation having wavelengths in a second, different waveband, and an optical element positioned to receive the combined optical radiation from the all-reflective shared optical sub-system and having a dichroic coating configured to transmit the first optical radiation and to reflect the second optical radiation, the optical element being configured to transmit the first optical radiation toward a first focal plane and to reflect and focus the second optical radiation to a second focal plane. The all-reflective shared optical sub-system and the optical element are each positioned symmetrically about a primary optical axis extending between the first focal plane and the second focal plane.

### BACKGROUND

There are numerous applications in which it is beneficial to be able to collect image data in multiple wavelength ranges (wavebands) concurrently, such as visible and infrared, or different regions of the infrared. Conventional sensors for multiple wavebands use multiple windows with the respective optics for each waveband. This approach adds cost and weight to the system, and is difficult to implement in volume-constrained platforms, such as weapon sights, missiles, and unmanned aerial vehicles (UAVs), for example. Certain other approaches, such as described in U.S. Pat. No. 6,174,061, for example, involve the use of dichroic beamsplitters to separate the light collected in the different wavebands, which results in the optical configurations being limited to collimated beams and/or reflective, long-F # or reimaged optics to accommodate the beamsplitter(s). Accordingly, these designs are also challenging to implement in volume-constrained platforms.

### SUMMARY OF INVENTION

Aspects and embodiments are directed to a compact dual-band sensor optical design with a shared aperture that may be particularly useful for volume constrained platforms.

According to one embodiment, a dual-band optical system comprises an all-reflective shared optical sub-system configured to receive combined optical radiation including first optical radiation having wavelengths in a first waveband and second optical radiation having wavelengths in a second waveband different from the first waveband, and an optical element positioned to receive the combined optical radiation from the all-reflective shared optical sub-system and having a dichroic coating configured to transmit the first optical radiation and to reflect the second optical radiation, the optical element being configured to transmit the first optical radiation toward a first focal plane and to reflect and focus the second optical radiation to a second focal plane, wherein the all-reflective shared optical sub-system and the optical element are each positioned symmetrically in a first dimension about a primary optical axis extending along a second dimension between the first focal plane and the second focal plane, the first and second dimensions being orthogonal to one another.

In one example, the all-reflective shared optical sub-system includes a primary mirror, a secondary mirror, and a tertiary mirror, the primary mirror being positioned and configured to receive the combined optical radiation via a system aperture and to reflect the combined optical radiation to the secondary mirror, the secondary mirror being positioned and configured to receive the combined optical radiation reflected from the primary mirror and to reflect the combined optical radiation to the tertiary mirror, and the tertiary mirror being positioned and configured to receive the combined optical radiation reflected from the secondary mirror and to reflect the combined optical radiation to the optical element. In one example, the optical element is a quaternary mirror. In another example, the quaternary mirror is a monolithic piece fabricated on a single substrate with the secondary mirror. In another example, the primary mirror and the tertiary mirror are formed as surface regions on a common first substrate. In another example, the secondary mirror and the quaternary mirror are formed as surface regions on a common second substrate. In one example, the common second substrate is made of zinc sulfide. In another example, the common second substrate is made of a material that transmits the first optical radiation.

In certain examples, the dual-band optical system further comprises a refractive optical sub-system configured to receive the first optical radiation from the optical element and to focus the first optical radiation onto the first focal plane, the refractive optical sub-system being positioned symmetrically in the first dimension about the primary optical axis. In one example, the refractive optical sub-system includes at least one lens configured to correct aberrations in the first waveband.

The dual-band optical system may further comprise a first imaging sensor positioned at the first focal plane and configured to produce a first image of at least a portion of a viewed scene from the first optical radiation, and a second imaging sensor positioned at the second focal plane and configured to produce a second image of the viewed scene from the second optical radiation. In one example, the first waveband is a visible waveband ranging from 380 nanometers (nm) to 740 nm, and the first imaging sensor is a visible-band imaging sensor, the second waveband is a long-wave infrared (LWIR) waveband ranging from 8 micrometers (μm) to 15 μm, and the second imaging sensor is an LWIR-band sensor. In another example, the first waveband is a shortwave infrared (SWIR) waveband ranging from 1.4 micrometers (μm) to 3 μm, and the first imaging sensor is a SWIR-band imaging sensor, the second waveband is a LWIR waveband ranging from 8 μm to 15 μm, and the second imaging sensor is an LWIR-band sensor. In another example, the first imaging sensor is one of a visible-band imaging sensor and a SWIR-band imaging sensor, and the second imaging sensor is one of a LWIR-band imaging sensor and a mid-wave infrared (MWIR)-band imaging sensor.

According to another embodiment, a dual-band optical imaging system comprises a primary mirror configured to receive and reflect optical radiation from a viewed scene, a secondary mirror positioned and configured to receive and reflect the optical radiation reflected by the primary mirror, a tertiary mirror positioned and configured to receive and reflect the optical radiation reflected by the secondary mirror, a quaternary mirror positioned and configured to receive the optical radiation reflected by the tertiary mirror, the quaternary mirror including a dichroic coating configured to separate the optical radiation into a first waveband and a second waveband, the quaternary mirror being configured to transmit the first waveband toward a first focal plane and to reflect and focus the second waveband to a second focal plane, and at least one lens element configured to receive the first waveband from the quaternary mirror and to focus the first waveband onto the first focal plane.

In one example, the dual-band optical imaging system further comprises a first imaging sensor positioned at the first focal plane and configured to produce a first image of at least a portion of a viewed scene from the first waveband, and a second imaging sensor positioned at the second focal plane and configured to produce a second image of the viewed scene from the second waveband. In one example, the first waveband is a visible waveband ranging from 380 nanometers (nm) to 740 nm, and the first imaging sensor is a visible-band imaging sensor, and the second waveband is a long-wave infrared (LWIR) waveband ranging from 8 micrometers (μm) to 15 μm, and the second imaging sensor is an LWIR-band sensor. In another example, the first waveband is a shortwave infrared (SWIR) waveband ranging from 1.4 micrometers (μm) to 3 μm, and the first imaging sensor is a SWIR-band imaging sensor, and the second waveband is a LWIR waveband ranging from 8 μm to 15 μm, and the second imaging sensor is an LWIR-band sensor. In another example, the at least one lens includes a first lens and a second lens, the first lens being positioned between the quaternary mirror and the second lens along a primary optical axis of the optical system extending from the first focal plane to the second focal plane.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a diagram of an example of an optical system according to aspects of the present invention;

FIG. 2 is a diagram showing a portion of an example of the optical system of FIG. 1;

FIG. 3A is a table providing an optical prescription for a wide field-of-view configuration of an example of the optical system of FIG. 1, according to aspects of the present invention;

FIG. 3B is a table providing an optical prescription for a narrow field-of-view configuration of the example of the optical system of FIG. 1, according to aspects of the present invention

FIG. 4A is a graph of simulated modulation transfer function versus spatial frequency for a wide field of view configuration of one example of the optical system of FIG. 1; and

FIG. 4B is a graph of simulated modulation transfer function versus spatial frequency for a narrow field of view configuration of one example of the optical system of FIG. 1.

### DETAILED DESCRIPTION

There are many applications in which both day and night operability are desirable. For example, most sensors in weapon sights, missile seekers, and Intelligence, Surveillance, and Reconnaissance (ISR) platforms, require day and night operability. This often necessitates the use of thermal or long-wave infrared (LWIR) or Mid-Wave Infrared (MWIR) cameras, which have poor resolution due to diffraction. Visible and short-wave infrared (SWIR) sensors can provide good resolution, but have poor night time imaging capability, particularly at long ranges. Accordingly, to achieve both day and night imaging capability, certain optical systems are dual-band, including both an LWIR sensor for night time imaging and a visible or SWIR sensor for higher resolution daytime imaging, for example. However, as discussed above, conventional dual-band systems use multiple windows and sets of optics and take up large volumes.

Aspects and embodiments provide a dual-band optical imaging system in a compact package that can be used in volume-constrained platforms and other applications where a highly compact form may be desirable. As discussed in more detail below, two imaging sensors for different wavebands, such as a MWIR or LWIR sensor and a visible or SWIR sensor, can be combined in a very compact optical design in which the sensors share a common window, primary mirror, secondary mirror, and tertiary mirror. Embodiments of the optical system discussed herein allow the use of both SWIR and LWIR imaging sensors for searching, acquisition, recognition, and tracking targets from volume-constrained platforms, such as weapon sights, missile seekers, UAVs, and satellites, for example.

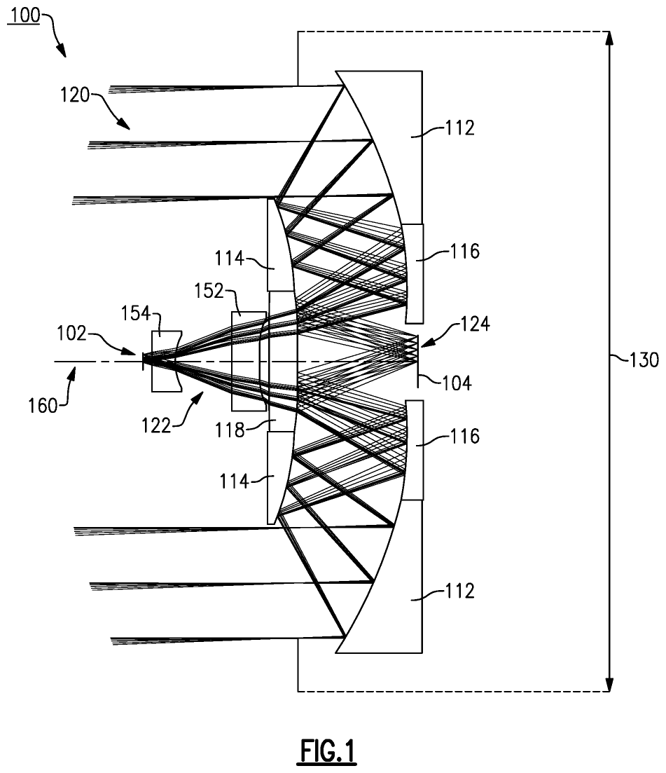

Referring to FIG. 1 there is illustrated a ray trace of one example of a dual-band optical imaging system 100 according to certain embodiments. The system 100 includes a first sensor 102 and a second sensor 104, the two sensors being operable in different wavebands. In one example, the first sensor 102 is a visible band (e.g., some or all of the wavelength range from about 380 nanometers (nm) to 740 nm) sensor. In another example, the first sensor 102 is a SWIR (wavelengths from about 1.4 micrometers (μm) to 3 μm) sensor. In certain examples, the second sensor 104 is an LWIR (wavelength range from about 8 μm to 15 μm) sensor. However, in other examples each of the first and second sensors 102, 104 may be operable in other wavebands.

The system 100 includes a primary mirror 112, a secondary mirror 114, and a tertiary mirror 116. Incoming optical radiation 120, which may include light in both wavebands, is received via a system aperture 130 at the primary mirror 112, reflected by the primary mirror 112 to the secondary mirror 114, reflected from the secondary mirror 114 to the tertiary mirror 116, and reflected by the tertiary mirror 116. Thus, the aperture 130, the primary mirror 112, the secondary mirror 114, and the tertiary mirror 116 are all shared by (or common to) the optical radiation 120 in both wavebands. In one example, the primary mirror 112 and the tertiary mirror 116 are formed as different regions on the same physical structure. For example, a substrate may be produced, for example, by injection molding or other techniques, and a surface of the substrate machined, for example, using diamond point turning or other techniques and polishing to shape and polish regions of the surface into mirror surfaces corresponding to the primary mirror 112 and the tertiary mirror 116. In certain examples, the substrate may be made of magnesium or a magnesium alloy, or example. Using diamond point turning or similar techniques allows different regions of the surface of the substrate to be formed with the correct surface figure or shape (e.g., spherical, conical, etc.) and any aspheric departures or other characteristics needed to produce the mirror surfaces corresponding to the optical prescription that defines the primary and tertiary mirrors 112, 116. In certain examples, the mirror surfaces can be polished or coated (e.g., with a metallic coating) and then polished to be highly reflective to the optical radiation 120 in both wavebands of interest. An advantage of having the three dual-waveband shared optical elements, namely the primary mirror 112, the secondary mirror 114, and the tertiary mirror 116, be reflective optical elements (mirrors), rather than refractive optical elements, is that reflective systems are generally compact and free of chromatic aberrations over a wide spectral range, which is particularly useful where the shared optical elements need to accommodate two different wavebands.

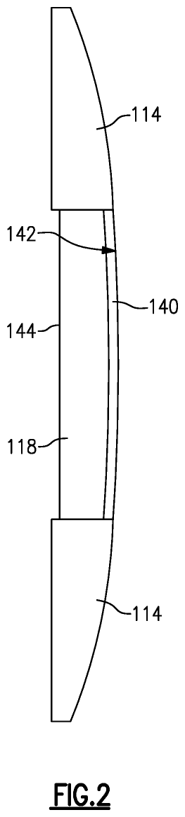

Referring to FIGS. 1 and 2, according to certain embodiments, the system 100 includes a fourth/quaternary mirror 118 that includes a dichroic surface coating 140 that is transmissive (substantially optically transparent) to first optical radiation 122 in the first waveband and reflective to second optical radiation 124 in the second waveband. Further, the quaternary mirror 118 itself may be made from a material that is transmissive to the first optical radiation 122. For example, where the first sensor is a SWIR sensor, the quaternary mirror may be made of zinc sulfide (ZnS), or other materials that are transmissive in the SWIR waveband. Thus, the quaternary mirror 118 transmits the first optical radiation 122 towards the first sensor 102 while reflecting the second optical radiation 124 in the second waveband toward the second sensor 104. The dichroic coating 140 acts to separate the incoming optical radiation 120 into the two wavebands (the first optical radiation 122 and the second optical radiation 124). In certain examples, the dichroic coating 140 may be implemented on an inner surface 142 of the front face of the quaternary mirror 118, as shown in FIG. 2; however, in other examples, the dichroic coating may be formed on the outer surface of the front face or on inner or outer surfaces of the rear face 144 of the quaternary mirror 118 to further correct optical aberrations in the second waveband. In certain examples, the secondary mirror 114 and the quaternary mirror 118 may be implemented as different regions on the same physical structure, similar to as discussed above for the primary and tertiary mirrors 112, 116. For example, the secondary mirror 114 and the quaternary mirror 118 may be formed by diamond point turning, or otherwise machining, the appropriate surface shapes (as defined by the optical prescription) onto regions of a common substrate, and then coating and polishing surface regions as needed. In certain examples the monolithic secondary/quaternary mirror structure can be separated, allowing the dichroic reflective/refractive lens element to be independently moved axially for further aberration corrections.

Still referring to FIG. 1, the system further a first lens 152, and a second lens 154 that receive the first optical radiation 122 via the fourth mirror 118 and focus the first optical radiation 122 onto a first focal plane at the first sensor 102. In certain examples, the first lens 152 and the second lens 154 may perform any necessary conditioning (e.g., collimation, de-collimation, magnification, demagnification, correction for optical aberrations, etc.) and focusing of the first optical radiation 122 for imaging at the first sensor 102. Further, although the first lens 152 and the second lens 154 are shown as individual single lens elements in the example illustrated in FIG. 1, they may be implemented in a variety of different ways in embodiment of the system 100. For example, the first lens 152 and the second lens 154 may be replaced with a single lens. In other examples, either or both the first lens 152 and the second lens 154 may be lens assemblies, each including two or more lens elements.

As shown in FIG. 1, in certain examples the optical system 100 is symmetric about a primary optical axis 160. For example, the primary mirror 112, secondary mirror 114, tertiary mirror 116, quaternary mirror 118, first lens 152, and second lens 154 may be positioned physically or optically centered about the primary optical axis 160, as shown. In addition, in certain examples, the primary mirror 112, secondary mirror 114, tertiary mirror 116, and/or quaternary mirror 118 may have surface shapes that are rotationally symmetric about the primary optical axis 160. The first lens 152 and/or second lens 154 may also be configured and positioned to be rotationally symmetric about the primary optical axis 160.

Thus, aspects and embodiments provide a dual-band optical imaging system capable of supporting infrared and visible imaging, and both daytime and night-time operation, in a compact package suitable for use in volume-constrained applications. Embodiments may combine advantageous properties of two different wavebands in a single compact system. For example, LWIR sensors provide a low-cost solution with both daytime and night-time operability, but have poor resolution, whereas SWIR (or visible) sensors provide better resolution but limited night-time operability. Embodiments of the optical system disclosed herein allow the use of both sensors in volume-constrained platforms. In certain examples, the optical system 100 can be configured with a short focal length and wide field of view for the lower-resolution LWIR or MWIR sensor, such that the optical system may be used for daytime or night-time detection and recognition of objects of interest, and configured with a long focal length and narrow field of view for the higher-resolution visible or SWIR sensor, such that the optical system 100 can also be used for identification of objects of interest detected using the LWIR sensor. Thus, a highly versatile, multi-function optical system with daytime and night-time operability can be provided in a highly compact volume.

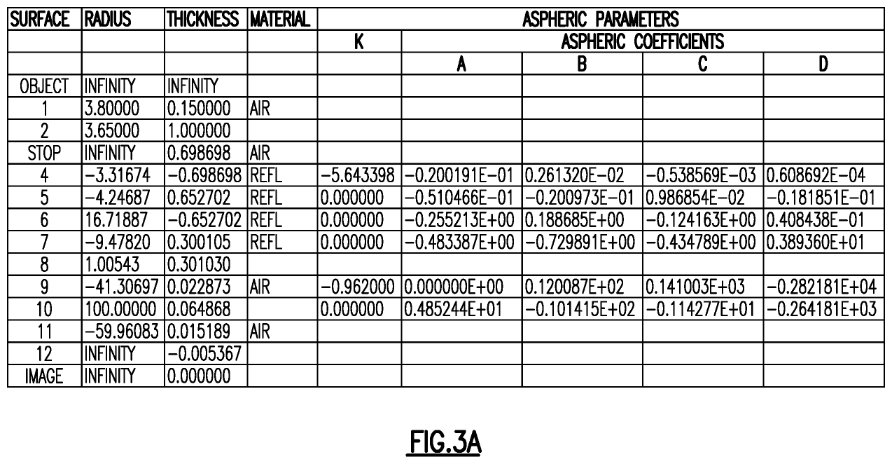

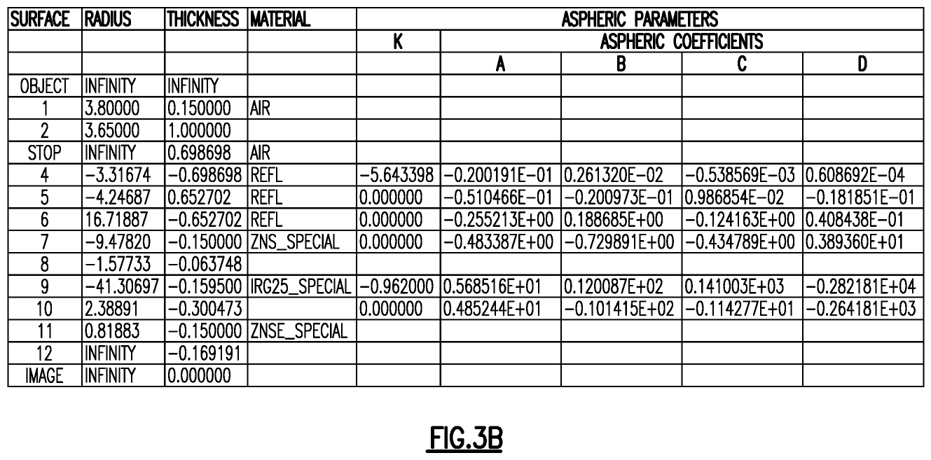

The tables of FIGS. 3A and 3B provide an example of an optical prescription for one embodiment of the optical system 100. Table 3A provides an optical prescription for a wide field of view configuration (e.g., for the second sensor 104 where the second sensor is an LWIR sensor, for example) of the optical system 100, and Table 3B provides an optical prescription for a narrow field of view configuration (e.g., for the first sensor 102 where the second sensor is an SWIR sensor or visible sensor, for example). The optical prescriptions for these examples may be generated using an equation and software that are industry standards and which would be known to those skilled in the art. It is to be appreciated however, that the prescriptions given in the tables of FIGS. 3A and 3B are merely exemplary, and that the prescriptions of various embodiments of the optical system 100 may be determined by the intended task(s) to be performed by the optical system and desired system characteristics. In the tables of FIGS. 3A and 3B, the column designated “Surface” identifies the optical element corresponding to the surface. The column designated “Radius” provides the radius of the respective surface, measured in inches. The minus sign indicates that the center of curvature is to the left of the mirror surface. The columns designated A, B, C, and D are the aspheric coefficients of the specific mirror surfaces in the industry-standard polynomial equation used to define aspheric surfaces. The column designated “K” describes the conic constant of the surface. The column designated “Thickness” provides the distance between distance between the respective surface and the next surface (identified in the adjacent lower row of the table), measured in inches. The column designated “Material” provides the material of the respective surface.

As discussed above, the optical system 100 may have a very compact physical form. For an example corresponding to the optical prescriptions given in the tables of FIGS. 3A and 3B, the aperture 130 may have an effective physical diameter of 3 inches, and the optical system 100 may have a physical length, measured along the primary optical axis 160 from the first sensor 102 to the second sensor 104, of 1.65 inches.

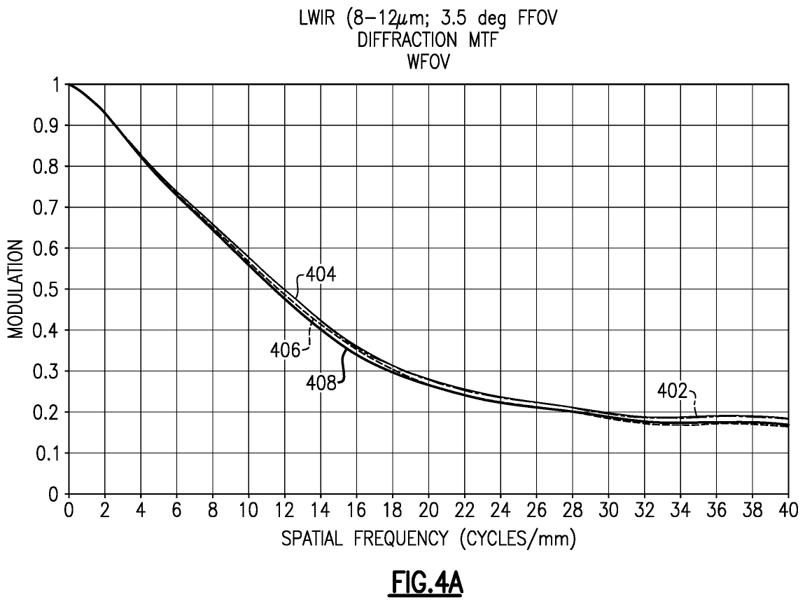

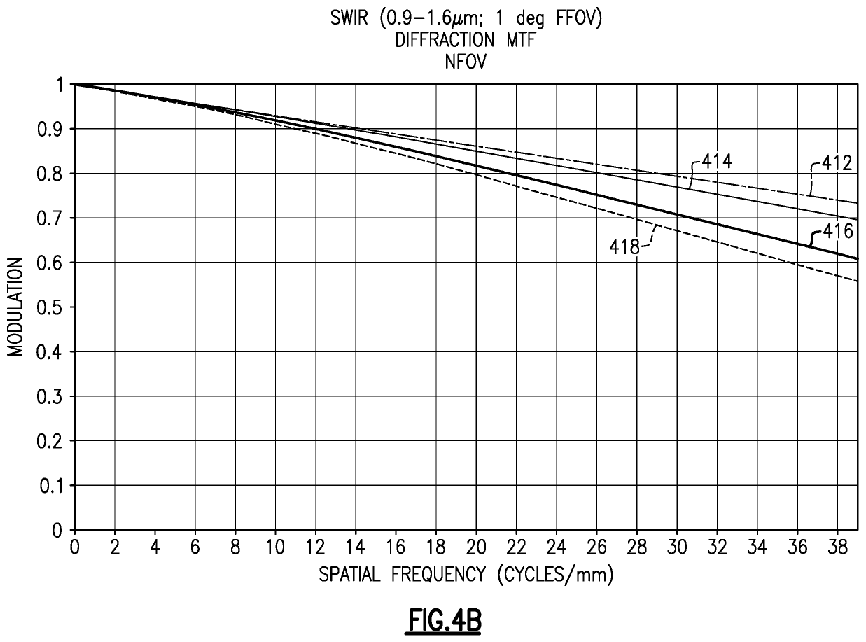

Embodiments of the optical system 100 may also provide good optical performance in both wavebands. FIGS. 4A and 4B provide simulated performance results for an example of the optical system 100 corresponding to the optical prescriptions given in the tables of FIGS. 3A and 3B. FIG. 4A is a graph of the system modulation transfer function (vertical axis) as a function of spatial frequency (horizontal axis, units of cycles per millimeter) for an example in which the second sensor 104 is an LWIR sensor. The simulation assumed a wavelength range of 8-12 μm and a field of view of the sensor 104 of 3.5 degrees. In FIG. 4A, curve 402 corresponds to the diffraction limit, and curve 404 corresponds to the simulation result at a field angle of 0 degrees. Curve 406 corresponds to the tangential modulation transfer function (MTF) curve at the edge of the field (1.75 degrees for the LWIR waveband), and curve 408 corresponds to the sagittal MTF curve at the edge of the field. FIG. 4B is a graph of the system modulation transfer function (vertical axis) as a function of spatial frequency (horizontal axis, units of cycles per millimeter) for an example in which the first sensor 102 is a SWIR sensor. The simulation assumed a wavelength range of 0.9-1.6 μm and a field of view of the sensor 102 of 1 degrees. In FIG. 4B, curve 412 corresponds to the diffraction limit, and curve 414 corresponds to the simulation result at a field angle of 0 degrees. Curve 416 corresponds to the tangential MTF curve at the edge of the field (0.5 degrees for the SWIR waveband), and curve 418 corresponds to the sagittal MTF curve at the edge of the field.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. It is to be appreciated that embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation. Accordingly, the foregoing description and drawings are by way of example only, and the scope of the invention should be determined from proper construction of the appended claims, and their equivalents.

What is claimed is:

1. A dual-band optical system comprising:
an all-reflective shared optical sub-system configured to receive combined optical radiation including first optical radiation having wavelengths in a first waveband and second optical radiation having wavelengths in a second waveband different from the first waveband; and
an optical element positioned to receive the combined optical radiation from the all-reflective shared optical sub-system and having a dichroic coating configured to transmit the first optical radiation and to reflect the second optical radiation, the optical element being configured to transmit the first optical radiation toward a first focal plane and to reflect and focus the second optical radiation to a second focal plane,
wherein the all-reflective shared optical sub-system and the optical element are each positioned symmetrically in a first dimension about a primary optical axis extending along a second dimension between the first focal plane and the second focal plane, the first and second dimensions being orthogonal to one another.

2. The dual-band optical system of claim 1 wherein the all-reflective shared optical sub-system includes a primary mirror, a secondary mirror, and a tertiary mirror, the primary mirror being positioned and configured to receive the combined optical radiation via a system aperture and to reflect the combined optical radiation to the secondary mirror, the secondary mirror being positioned and configured to receive the combined optical radiation reflected from the primary mirror and to reflect the combined optical radiation to the tertiary mirror, and the tertiary mirror being positioned and configured to receive the combined optical radiation reflected from the secondary mirror and to reflect the combined optical radiation to the optical element.

3. The dual-band optical system of claim 2 wherein the optical element is a quaternary mirror.

4. The dual-band optical system of claim 3 wherein the quaternary mirror is a monolithic piece fabricated on a single substrate with the secondary mirror.

5. The dual-band optical system of claim 3 wherein the primary mirror and the tertiary mirror are formed as surface regions on a common first substrate.

6. The dual-band optical system of claim 5 wherein the secondary mirror and the quaternary mirror are formed as surface regions on a common second substrate.

7. The dual-band optical system of claim 6 wherein the common second substrate is made of zinc sulfide.

8. The dual-band optical system of claim 6 wherein the common second substrate is made of a material that transmits the first optical radiation.

9. The dual-band optical system of claim 1 further comprising:
a refractive optical sub-system configured to receive the first optical radiation from the optical element and to focus the first optical radiation onto the first focal plane, the refractive optical sub-system being positioned symmetrically in the first dimension about the primary optical axis.

10. The dual-band optical system of claim 9 wherein the refractive optical sub-system includes at least one lens configured to correct aberrations in the first waveband.

11. The dual-band optical system of claim 1 further comprising:
a first imaging sensor positioned at the first focal plane and configured to produce a first image of at least a portion of a viewed scene from the first optical radiation; and
a second imaging sensor positioned at the second focal plane and configured to produce a second image of the viewed scene from the second optical radiation.

12. The dual-band optical system of claim 11 wherein the first waveband is a visible waveband ranging from 380 nanometers (nm) to 740 nm, and the first imaging sensor is a visible-band imaging sensor; and wherein the second waveband is a long-wave infrared (LWIR) waveband ranging from 8 micrometers (μm) to 15 μm, and the second imaging sensor is an LWIR-band sensor.

13. The dual-band optical system of claim 11 wherein the first waveband is a shortwave infrared (SWIR) waveband ranging from 1.4 micrometers (μm) to 3 μm, and the first imaging sensor is a SWIR-band imaging sensor; and wherein the second waveband is a long-wave infrared (LWIR) waveband ranging from 8 μm to 15 μm, and the second imaging sensor is an LWIR-band sensor.

14. The dual-band optical system of claim 11 wherein the first imaging sensor is one of a visible-band imaging sensor and a shortwave infrared (SWIR)-band imaging sensor, and the second imaging sensor is one of a long-wave infrared (LWIR)-band imaging sensor and a mid-wave infrared (MWIR)-band imaging sensor.

15. A dual-band optical imaging system comprising:
a primary mirror configured to receive and reflect optical radiation from a viewed scene;
a secondary mirror positioned and configured to receive and reflect the optical radiation reflected by the primary mirror;
a tertiary mirror positioned and configured to receive and reflect the optical radiation reflected by the secondary mirror;
a quaternary mirror positioned and configured to receive the optical radiation reflected by the tertiary mirror, the quaternary mirror including a dichroic coating configured to separate the optical radiation into a first waveband and a second waveband, the quaternary mirror being configured to transmit the first waveband toward a first focal plane and to reflect and focus the second waveband to a second focal plane; and
at least one lens element configured to receive the first waveband from the quaternary mirror and to focus the first waveband onto the first focal plane.

16. The dual-band optical imaging system of claim 15 further comprising:
a first imaging sensor positioned at the first focal plane and configured to produce a first image of at least a portion of a viewed scene from the first waveband; and
a second imaging sensor positioned at the second focal plane and configured to produce a second image of the viewed scene from the second waveband.

17. The dual-band optical imaging system of claim 16 wherein the first waveband is a visible waveband ranging from 380 nanometers (nm) to 740 nm, and the first imaging sensor is a visible-band imaging sensor; and wherein the second waveband is a long-wave infrared (LWIR) waveband ranging from 8 micrometers (μm) to 15 μm, and the second imaging sensor is an LWIR-band sensor.

18. The dual-band optical imaging system of claim 16 wherein the first waveband is a shortwave infrared (SWIR) waveband ranging from 1.4 micrometers (μm) to 3 μm, and the first imaging sensor is a SWIR-band imaging sensor; and wherein the second waveband is a long-wave infrared (LWIR) waveband ranging from 8 μm to 15 μm, and the second imaging sensor is an LWIR-band sensor.

19. The dual-band optical imaging system of claim 16 wherein the at least one lens includes a first lens and a second lens, the first lens being positioned between the quaternary mirror and the second lens along a primary optical axis of the optical system extending from the first focal plane to the second focal plane.
